(19) United States
(12) Patent Application Publication
(10) Pub. No.: US 2013/0019104 A1
(43) Pub. Date: Jan. 17, 2013

(54) CELL LEVEL DATA ENCRYPTION

(71) Applicants: Miroslav Halas, Charlottesville, VA (US); Rangarajan Umamaheswaran, Simi Valley, CA (US)

(72) Inventors: Miroslav Halas, Charlottesville, VA (US); Rangarajan Umamaheswaran, Simi Valley, CA (US)

(73) Assignee: BANK OF AMERICA CORPORATION, CHARLOTTE, NC (US)

(21) Appl. No.: 13/182,216

(22) Filed: Jul. 13, 2011

(51) Int. Cl. G06F 21/24

(52) U.S. Cl. 713/189

(57) ABSTRACT

Embodiments of the invention provide for cell level data encryption. The methods, apparatus and computer program products herein described provide for the encryption of individual data values without requiring adjacent data valued to also be encrypted. For example, in situations where individual data values are arranged in a database that is visualized as a two-dimensional representation, individual data values may be encrypted without requiring horizontally or vertically adjacent data values to also be encrypted. In situations where data values is transmitted and visualized as a sequential stream of data values, one data value may be encrypted without requiring previous or subsequent data values to be encrypted. In some such examples, an individual data value may be encrypted without requiring the entire transmission channel to be encrypted.

### FIELD

In general, embodiments of the invention relate to data security and, more particularly, methods, devices and computer program products for cell level data encryption, wherein a portion of a plurality of data values may be encrypted during storage, transmission and/or viewing, in response to receiving information regarding an aspect of the plurality of data values.

### BACKGROUND

Many people have adopted increasingly busy lifestyles and gained high levels of comfort with technology. In this regard, customers of many entities have demanded the ability to conduct personal business over the phone, over the Internet, and through other technological means. In response to this demand, many businesses, including financial institutions, have augmented their traditional, in-person business facilities with online presences, customer call centers, automated machines, and other avenues for conducting business remotely. As customers have come to enjoy and rely on the level of service and convenience afforded by such augmented facilities, customers have begun to expect a high degree of access, speed, and efficiency from the remote facilities that they use to conduct business transactions. In seeking to meet such customer expectations, some entities have deployed employees and agents in multiple different physical locations, and implemented technologies that allow such employees to rapidly access sensitive customer information that is stored remotely.

Unfortunately, the sophistication of criminals who seek to misappropriate, misuse, and otherwise exploit customer information for improper purposes, such as identity thieves, has grown in parallel with the popularity of services that allow customers to conduct business online, over the phone, or through other technological means. Some sophisticated criminals, rather than directly targeting physical assets such as cash, bearer bonds, or other physical assets, instead seek to misappropriate sensitive customer information by attacking the data storage media and transmission channels that hold and carry such sensitive information.

Given the increasing expectations of customers and the increasing sophistication of criminals seeking to obtain sensitive customer information, the need to efficiently protect sensitive information while allowing access to non-sensitive information that allows for customer service has arisen.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. This summary's sole purpose is to present some concepts of one or more embodiments in a simplified form as a prelude to the more detailed description that is presented later.

Thus, further details are provided below for cell level data encryption. The methods, apparatus and computer program products herein described provide for the encryption of individual data values without requiring adjacent data values to also be encrypted. For example, in situations where individual data values are arranged in a database that is visualized as a two-dimensional representation, individual data values may be encrypted without requiring horizontally or vertically adjacent data values to also be encrypted. In situations where data values are transmitted and visualized as a sequential stream of data values, one data value may be encrypted without requiring previous or subsequent data values to be encrypted. In some such examples, an individual data value may be encrypted without requiring the entire transmission channel to be encrypted.

A method for cell level data encryption defines first embodiments of the invention. In example embodiments, the method includes receiving via a computing device an identifier of an aspect of a plurality of data values; in response to receiving via a computing device the identifier associated with an aspect of the plurality of data values, applying via a computing device processor an encryption protocol to the plurality of data values such that a first data value in the plurality of data values is encrypted and a second data value in the plurality of data values is unencrypted; and providing a modified plurality of data values, comprising an encrypted copy of the first data value and an unencrypted copy of the second data value.

In some example implementations, the plurality of data values comprises a database and is stored in a computer-readable medium. In some of these and in other example embodiments, the plurality of data values is a portion of a transmission.

In some example implementations, the identifier of an aspect of a plurality of data values comprises an identification of an application associated with the plurality of data. In some of these and in other example implementations, the identifier of an aspect of a plurality of data values includes an identification of an application associated with the plurality of data and an identification of a data format associated with the application.

In some of these example implementations, and in other example implementations, applying via a computing device processor an encryption protocol to the plurality of data values such that a first data value in the plurality of data values is encrypted and a second data value in the plurality of data values is unencrypted includes identifying via a computing device processor the identification of an application associated with the plurality of data and the identification of a data format associated with the application; and selecting via a computing device processor an encryption protocol from among a plurality of encryption protocols, wherein the selected protocol is associated with the identification of an application associated with the plurality of data and the identification of a data format associated with the application.

In some example implementations, the method further includes receiving via a computing device a request for the first data value; determining via a computing device processor that the request for the first data value includes an authorization to view the first data value; and in response to determining that the request comprises an authorization to view the first data value, providing via a computer device processor for production of an unencrypted copy of the first data value.

In some example embodiments in accordance with an aspect of the invention, a method for cell-level data encryption, includes receiving via a computing device a plurality of data values, wherein the plurality of data values is configured as a spreadsheet, wherein the spreadsheet comprises a plurality of cells; receiving via a computing device an identifier of an aspect of a plurality of data values, wherein the identifier is associated with a monitoring application; in response to receiving via a computing device the identifier associated with an aspect of the plurality of data values, applying via a computing device processor an encryption protocol to the plurality of data values such that a first data value stored in a first cell of the spreadsheet is encrypted and a second data value stored in a second cell of the spreadsheet is unencrypted; and providing a modified spreadsheet, comprising an encrypted copy of the first data value and an unencrypted copy of the second data value.

In some example implementations of such embodiments, the plurality of data values includes data regarding an interaction between an employee of a financial institution and information associated with a customer of the financial institution.

In some such example implementations, and in other example implementations, the monitoring application records data regarding an action performed by an employee of a financial institution.

An apparatus for encrypting data defines a second aspect of the invention. In example embodiments, the apparatus includes a computing device comprising a memory and at least one processor; and a cell level data encryption application stored in the memory and executable by the processor to receive an identifier of an aspect of a plurality of data values; in response to receiving the identifier associated with an aspect of the plurality of data values, apply an encryption protocol to the plurality of data values such that a first data value in the plurality of data values is encrypted and a second data value in the plurality of data values is unencrypted; and provide a modified plurality of data values, comprising an encrypted copy of the first data value and an unencrypted copy of the second data value.

In some example implementations, the plurality of data values includes a database and is stored in a computer-readable medium. In some of these and in other example implementations, the plurality of data values is a portion of a transmission.

In some example implementations, the identifier of an aspect of a plurality of data values comprises an identification of an application associated with the plurality of data. In some of these, and in other example implementations, the identifier of an aspect of a plurality of data values comprises an identification of an application associated with the plurality of data and an identification of a data format associated with the application. In some such example implementations, and in other example implementations, the cell level data encryption application is further configured to identify the identification of an application associated with the plurality of data and the identification of a data format associated with the application; and select an encryption protocol from among a plurality of encryption protocols, wherein the selected protocol is associated with the identification of an application associated with the plurality of data and the identification of a data format associated with the application.

In some example implementations, the cell level data encryption application is further configured to receive a request for the first data value; determine that the request for the first data value comprises an authorization to view the first data value; and in response to determining that the request comprises an authorization to view the first data value, provide for production of an unencrypted copy of the first data value.

A computer program product defines a third aspect of the invention. In example embodiments, the computer program product includes a non-transitory computer-readable medium which includes: a first set of codes for causing a computer to be configured for receiving via a computing device an identifier of an aspect of a plurality of data values; a second set of codes for causing a computer to be configured for in response to receiving via a computing device the identifier associated with an aspect of the plurality of data values, applying via a computing device processor an encryption protocol to the plurality of data values such that a first data value in the plurality of data values is encrypted and a second data value in the plurality of data values is unencrypted; and a third set of codes for causing a computer to be configured for providing a modified plurality of data values, including an encrypted copy of the first data value and an unencrypted copy of the second data value.

In some example implementations, the plurality of data values includes a database and is stored in a computer-readable medium. In some of these, and in other example implementations, the plurality of data values is a portion of a transmission.

In some example implementations, the identifier of an aspect of a plurality of data values includes an identification of an application associated with the plurality of data. In some of these, and in other example implementations, the identifier of an aspect of a plurality of data values includes an identification of an application associated with the plurality of data and an identification of a data format associated with the application. In some such implementations, and in other example implementations, the second set of codes for causing a computer to be configured for applying via a computing device processor an encryption protocol to the plurality of data values such that a first data value in the plurality of data values is encrypted and a second data value in the plurality of data values is unencrypted includes a fourth set of codes for causing a computer to be configured for identifying via a computing device processor the identification of an application associated with the plurality of data and the identification of a data format associated with the application; and a fifth set of codes for causing a computer to be configured for selecting via a computing device processor an encryption protocol from among a plurality of encryption protocols, wherein the selected protocol is associated with the identification of an application associated with the plurality of data and the identification of a data format associated with the application.

In some example implementations, the computer program product further includes a fourth set of codes for causing a computer to be configured for receiving via a computing device a request for the first data value; a fifth set of codes for causing a computer to be configured for determining via a computing device processor that the request for the first data value comprises an authorization to view the first data value; and a sixth set of codes for causing a computer to be configured for in response to determining that the request comprises an authorization to view the first data value, providing via a computer device processor for production of an unencrypted copy of the first data value.

Thus, as described in further detail below, embodiments of the invention provide cell level data encryption. The methods, apparatus and computer program products described in more detail below provide for exerting control over data encryption such that individual data values may be encrypted without requiring adjacent data values and/or transmission channels to also be encrypted.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a flow diagram of a method for cell level data encryption, in accordance with embodiments of the present invention.

FIG. 2 is a flow diagram of a method for cell level data encryption, in accordance with embodiments of the present invention.

FIG. 3 is a block diagram of an apparatus configured to perform cell level data encryption in accordance with embodiments of the present invention.

FIG. 4 is a depiction of databases described in relation to an illustrative example of an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, further details are provided below for cell level data encryption. Some implementations contemplate exerting control over data encryption, including very fine-grained control over data protection via encryption. In some example implementations, individual data values may be encrypted without requiring adjacent data values and/or transmission channels to also be encrypted. For example, in situations where data values are stored in a database and visualized as a two-dimensional spreadsheet, example implementations allow for the encryption of an individual data value without requiring that horizontally or vertically adjacent data values, and/or other data values in the same row or column, be encrypted. In some example implementations where the data is stored and/or visualized as a two-dimensional spreadsheet, data may be encrypted at the cell-level. In some such example implementations, one or more individual cells within the spreadsheet may be encrypted without requiring horizontally or vertically adjacent cells to be encrypted.

Some example implementations also contemplate providing for cell level data encryption, such as the encryption of a single data value, in situations where the data is in flight and/or in transit via a transmission line or channel, including, but not limited to, wired interfaces and wireless interfaces. Example implementations also contemplate providing for encryption of individual data values in situations where the data is stored and/or arranged in other structures, such as data arranged in an XML format.

Regardless of whether the data is at rest, such as when the data is stored in a computer-readable memory, or in transit, example implementations of cell level data encryption contemplate selectively encrypting sensitive data and/or potentially sensitive data. In situations where encryption is computationally expense, such as situations where encryption consumes additional computer resources to protect data, example implementations of cell level data encryption protect sensitive data without needlessly expending computer resources to protect data that is not sensitive, which often occurs when an entire database, data record, and/or transmission channel is encrypted.

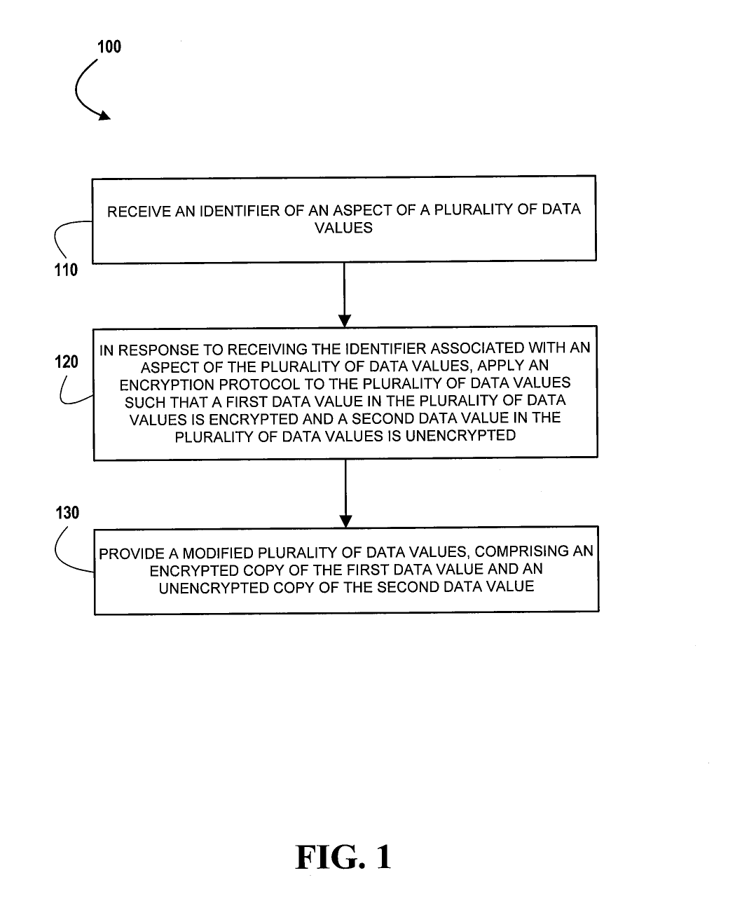

FIG. 1 is a flow chart depicting an example process flow 100 in accordance with an aspect of the invention. As shown in FIG. 1, element 110 includes receiving an identifier of an aspect of a plurality of data values. FIG. 1 also depicts element 120, which includes, in response to receiving the identifier associated with an aspect of the plurality of data values, applying an encryption protocol to the plurality of data values such that a first data value in the plurality of data values is encrypted and a second data value in the plurality of data values is unencrypted. Also shown in FIG. 1 is element 130, which includes providing a modified plurality of data values, including an encrypted copy of the first data value and an unencrypted copy of the second data value.

As used herein, the term data value means any piece of information that is capable of being encrypted, including, but not limited to pieces of computer-readable information stored in a memory device, and/or pieces of information transmitted via a transmission channel, such as information that is transmitted over a wired connection, optical and/or wireless connection.

In some example implementations of element 110, the plurality of data values includes and/or is part of a database that is stored in a computer-readable medium. It will be appreciated that any type of database or other data structure may be used in implementations of element 110. In some of these example implementations, and in other example implementations, the plurality of data values includes or is part of a portion of a transmission. It will be appreciated that any type of transmission may be used in implementations of element 110, including but not limited to transmissions carried on wired connections, optical connections and/or transmissions carried on wireless connections, including but not limited to transmissions over an air interface.

As used herein, the term identifier of an aspect of a plurality of data values means any piece of information that allows for the detection and/or discernment of an aspect of one or more data values in the plurality of data values. For example, the identifier might indicate the source of several data values, might indicate a category that defines an aspect of one or more data values, or might indicate a configuration of one or more data values. In some example implementations of element 110, the identifier of an aspect of a plurality of data values includes an identification of an application associated with the plurality of data. In some such example implementations of element 110, and in other example implementations, the identifier of an aspect of a plurality of data values includes an identification of an application associated with the plurality of data and an identification of a data format associated with the application. However, it will be appreciated that any identifier of an aspect of a plurality of data values may be used in implementations of element 110, including but not limited to an identification of an application, record type, and/or individual field within a record.

Some example implementations of element 110 contemplate a database and/or a transmission that includes a plurality of data records, wherein each individual data record includes one or more data value, and wherein each data record is received from one of a plurality of computer applications. In some such examples, the database and/or transmission may be structured such that each application from which a data record is received is assigned a unique identifier, such as an application number. For example, a first application might be assigned the unique identifier APPLICATION_IDENTIFIER_1, and a second application might be assigned the unique identifier APPLICATION_IDENTIFIER_2. In some such examples, the unique identifier may take the form of a number, a name of the application, or any other alpha-numeric sequence that serves to identify the application.

In some example implementations, one or more of the applications from which information is received is an application in which actions taken by agents and/or employees of an entity, such as employees of a financial institution, are monitored. In some such implementations, the application monitors actions taken with regard to customer information. For example, the application may generate a record regarding specific actions such as an employee of a financial institution requesting a customer credit report, and the record may contain potentially sensitive customer information, such as the customer's social security number. It will be appreciated, however that information may be received from any type of application, including, but not limited to any type of application that monitors actions taken by an employee, agent, and/or other user of an entity's resources.

Some example implementations contemplate the existence of one or more record types associated with a single application. These record types may establish one or more data formats wherein various data values corresponding to various data fields are presented and/or transmitted in a particular format or sequence. For example, a database and/or transmission may include information from an application identified as APPLICATION_IDENTIFIER_1 that can take the form of a first type of record or a second type of record. In such examples, the identifier associated with the first type of record may be assigned the identifier of RECORD_IDENTIFIER_1, and the second type of record may be assigned the identifier of RECORD_IDENTIFIER_2. It will be appreciated that the identifier of a data format may take the form of a number, a name of a record type or any other alpha-numeric sequence that serves to identify the record type and/or data format.

In an example implementation of element 110, a single application, such as the application with the identifier APPLICATION_IDENTIFIER_1 is capable of sending records in two different data formats, identified as RECORD_IDENTIFIER_1 and RECORD_IDENTIFIER_2. In such an example, information sent in accordance with the format established in accordance with RECORD_IDENTIFIER_1 may sequence several data values to include a customer name, followed by a customer social security number, which is, in turn, followed by a date that the record was received. In such an example implementation, information sent in accordance with the format established in accordance with RECORD_IDENTIFIER_2 may sequence several data values to include a customer phone number, followed by a customer address. However, it will be appreciated that other sequences of data values may be used in example implementations of element 110.

As shown in FIG. 1, element 120 includes, in response to receiving the identifier associated with an aspect of the plurality of data values, applying an encryption protocol to the plurality of data values such that a first data value in the plurality of data values is encrypted and a second data value in the plurality of data values is unencrypted. It will be appreciated that any approach to encrypting a data value may be used in implementations of element 120, including but not limited to processing a data value in accordance with any encryption algorithm and/or method now known or developed later.

As used herein, the term encryption protocol refers to an approach to selecting one or more data values within the plurality of data values for encryption. For example, in some implementations of element 120, the identifier associated with an aspect of the plurality of data values is correlated to an encryption protocol that dictates that a particular data value in the plurality of data values should be encrypted. In one such example, the identifier associated with APPLICATION_IDENTIFIER_1 is correlated with an encryption protocol that calls for the third data value in a particular data record to be encrypted. In such an example implementation, in response to receiving APPLICATION_IDENTIFIER_1, an encryption protocol is applied such that the third data value in the particular record is encrypted, and the first, second, and any other data values in that particular record are left unencrypted.

In some example implementations of element 120, applying an encryption protocol to the plurality of data values such that a first data value in the plurality of data values is encrypted and a second data value in the plurality of data values is unencrypted includes identifying the identification of an application associated with the plurality of data and the identification of a data format associated with the application. Some such example implementations of element 120 also include selecting an encryption protocol from among a plurality of encryption protocols, wherein the selected protocol is associated with the identification of an application associated with the plurality of data and the identification of a data format associated with the application.

In some of these, and in other example implementations, a plurality of encryption protocols may be stored in a computer-readable memory, wherein each encryption protocol is associated with an identification of an application and an identification of a data format. For example, a first encryption protocol may be associated with the identification of an application APPLICATION_IDENTIFIER_1 and the identification of a data format RECORD_IDENTIFIER_1, while a second encryption protocol is associated with a different set of identifications, such as APPLICATION_IDENTIFIER_N and RECORD_IDENTIFIER_Z. Since the first encryption protocol is associated with APPLICATION_IDENTIFIER_1 and RECORD_IDENTIFIER_1, in such example implementations, the first encryption protocol is applied when those identifiers are received.

As shown in FIG. 1, element 130 includes providing a modified plurality of data values, including an encrypted copy of the first data value and an unencrypted copy of the second data value. In some example implementations of element 130, such as implementations that occur in a database environment, the encrypted copy of the first data value is stored in the database and replaces the previously unencrypted copy of the first data value, while the other data values in the database are left unencrypted. In some example implementations of element 130, such as implementations that are applied to a transmission, the encrypted copy of the first data value is transmitted instead of the previously unencrypted copy of the first data value, while the other unencrypted data values remain unencrypted.

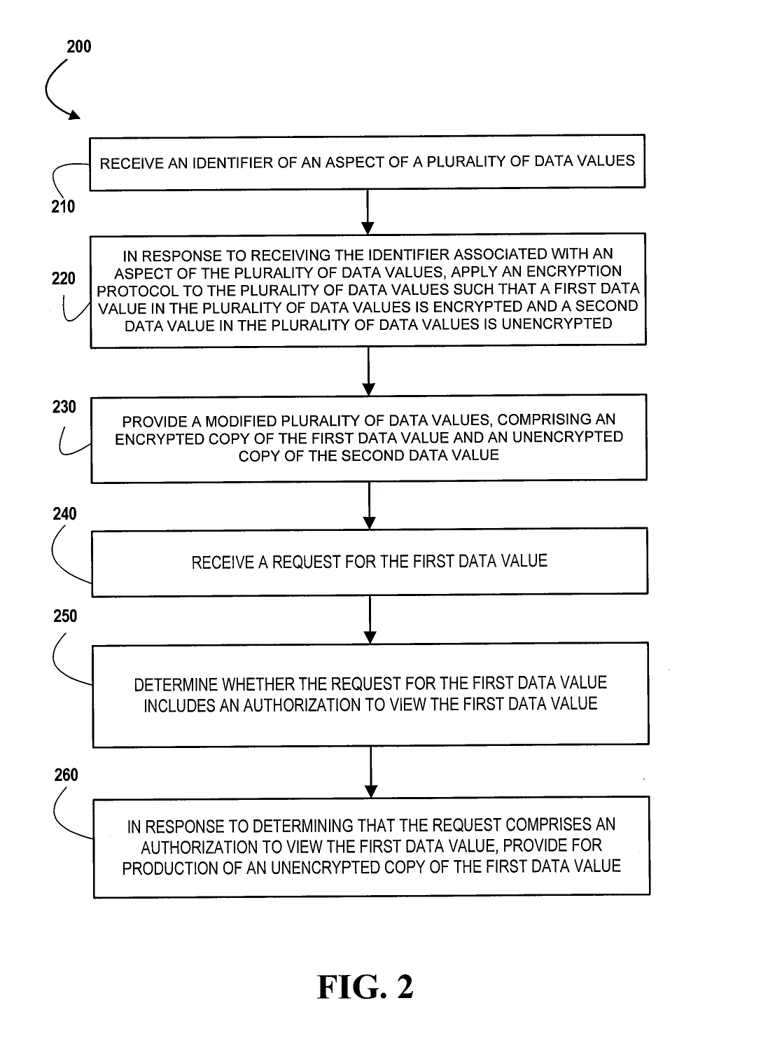

FIG. 2 is a flow diagram of process flow 200. As shown in FIG. 2, element 210 includes receiving an identifier of an aspect of a plurality of data values. It will be appreciated that any approach to receiving an identifier of an aspect of a plurality of data values may be used in implementations of element 210, including, but not limited to, those approaches discussed herein with respect to element 110 in FIG. 1.

Element 220 includes, in response to receiving the identifier associated with an aspect of the plurality of data values, applying an encryption protocol to the plurality of data values such that a first data value in the plurality of data values is encrypted and a second data value in the plurality of data values is unencrypted. It will be appreciated that any approach to, in response to receiving the identifier associated with an aspect of the plurality of data values, applying an encryption protocol to the plurality of data values such that a first data value in the plurality of data values is encrypted and a second data value in the plurality of data values is unencrypted may be used in implementations of element 220, including, but not limited to the approaches described herein with respect to element 120 in FIG. 1.

Element 230 includes providing a modified plurality of data values, including an encrypted copy of the first data value and an unencrypted copy of the second data value. It will be appreciated that any approach to providing a modified plurality of data values, including an encrypted copy of the first data value and an unencrypted copy of the second data value may be used in implementations of element 230, including but not limited to the approaches described herein with respect to element 130 in FIG. 1.

As shown in FIG. 2, element 240 includes receiving a request for the first data value. It will be appreciated that any approach to receiving a request for the first data value be used in implementations of element 240. In some example implementations, an individual associated with an entity, such as an employee of a financial institution, may request information regarding a customer in the course of conducting the employee's job. In some such examples, an individual may query a database or send a transmission requesting the customer information.

FIG. 2 also depicts element 250, which includes determining that the request for the first data value includes an authorization to view the first data value. Extending the example implementation described herein with respect to element 240, in some situations the employee may be authorized to view one or more pieces of potentially sensitive information that have been previously encrypted. In such an example situation, the request for the first data value may include an indication of an authorization to view the requested data in its unencrypted form. For example, a piece of sensitive customer information that was previously encrypted and stored in a database may be necessary for an employee to process a particular loan application for the customer. If the employee is authorized to view the unencrypted data, a processor and/or other device may receive the request, and determine that the request includes an authorization to view the encrypted information. However, it will be appreciated that any approach to determining that the request for the first data value includes an authorization to view the first data value may be used in implementations of element 250.

As shown in FIG. 2, element 260 includes, in response to determining that the request includes an authorization to view the first data value, providing for production of an unencrypted copy of the first data value. In some example implementations of element 260, providing for the production of an unencrypted copy of the first data value may include presenting an unencrypted copy of the first data value to a user via a display or other user interface. Some such implementations may be used in situations where the encrypted information is stored and/or received by the same device and/or system from which an authorized request to view the first data value originated. In such example implementations and in other example implementations of element 260, providing for the production of an unencrypted copy of the first data value may include transmitting data and/or instructions to a device and/or system to enable software stored on the device and/or system to decrypt an encrypted data value. Some such implementations may be used in situations where the first data value needs to be transmitted over a transmission channel or a network in order to fulfill an authorized request to view an unencrypted copy of the first data value, because the first data value remains encrypted until it is processed at its destination. However, it will be appreciated that any approach to, in response to determining that the request includes an authorization to view the first data value, providing for production of an unencrypted copy of the first data value may be used in implementations of element 260.

Some example implementations of process flows 100 and 200 may be appropriate in situations that contemplate a spreadsheet. In some such example implementations, a plurality of data values may be received, wherein the plurality of data values is configured as a spreadsheet, which includes a plurality of cells. In such example implementations, a cell in a spreadsheet is present at the intersection of a row and a column in the spreadsheet.

In some such example implementations, an identifier associated with a monitoring application is also received. In some example implementations that contemplate a monitoring application associated with a financial institution, the monitoring application may be an application that observes and/or records information related to actions taken by employees, including but not limited to actions taken by employees that include an interaction with customer information.

In some such implementations that contemplate a spreadsheet, data values may be encrypted such that a data value in one cell is encrypted while a data value in a second cell is not encrypted. It will be appreciated that individual cells within the spreadsheet may be encrypted, without requiring horizontally or vertically adjacent cells to be encrypted.

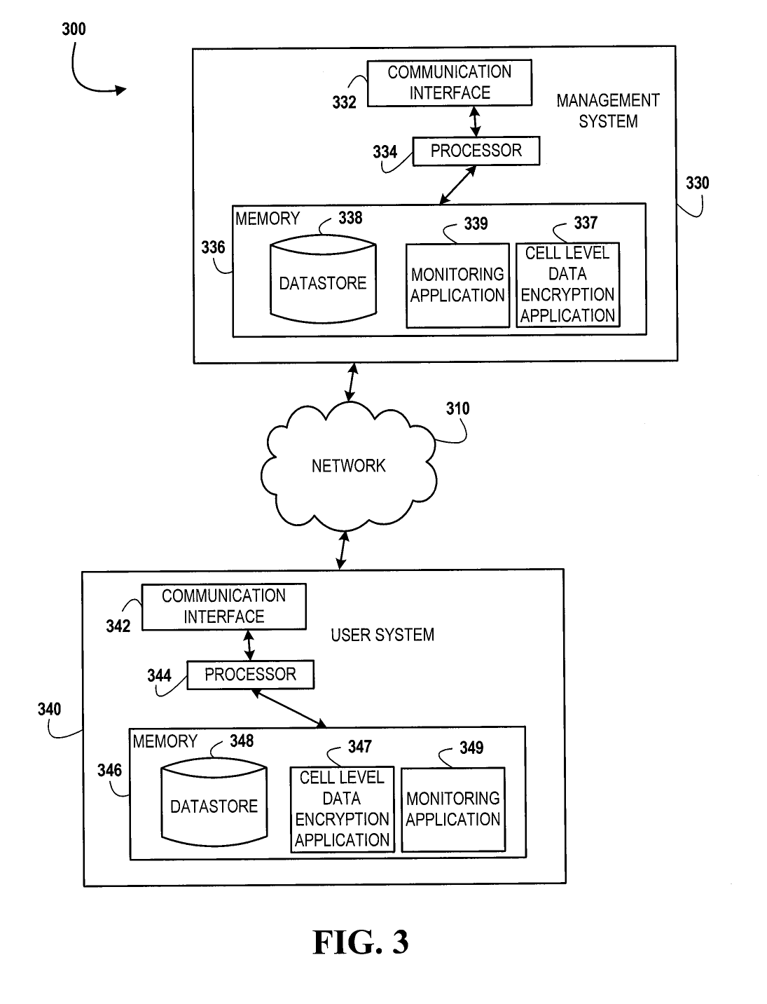

FIG. 3 presents a system and environment 300 for performing cell level data encryption in accordance with an embodiment of the present invention. As shown, system 300 includes a network 310, a management system 330, and a user system 340. In the example embodiment depicted in FIG. 3, the management system 330 and the user system 340 is maintained by an entity, such as a financial institution or other entity, such as a retailer, service provider, private club, organization, and/or individual interacts with and/or maintains sensitive data. In some example implementations, the user system 340 is used by an employee of the entity in the conduct of the entity's business, such as interacting with customers and customer information.

As shown in FIG. 3, the management system 330 is operatively and selectively connected to the network 310, which may include one or more separate networks. The user system 340 is also operatively and selectively connected to network 310. In addition, the network 310 may include a local area network (LAN) such as an intranet, a wide area network (WAN), and/or a global area network (GAN), such as the Internet. It will also be understood that the network 310 may be secure and/or unsecure and may also include wireless and/or wireline and/or optical interconnection technology.

As depicted, the management system 330 may include any computerized apparatus that can be configured to perform any one or more of the functions described and/or contemplated herein. In accordance with some embodiments, for example, the management system 330 may include a computer network, an engine, a platform, a server, a database system, a front end system, a back end system, a personal computer system, and/or the like. In some embodiments, such as the one illustrated in FIG. 3, the management system 330 includes a communication interface 332, a processor 334, and a memory 336, which includes a datastore 338 and a cell level data encryption application 337. Also shown in memory 336 is a monitoring application 339. As shown, the communication interface 332 is operatively and selectively connected to the processor 334, which is operatively and selectively connected to the memory 336.

As depicted, the user system 340 may include any computerized apparatus that can be configured to perform any one or more of the functions described and/or contemplated herein. In accordance with some embodiments, for example, the user system 340 may include a computer network, an engine, a platform, a server, a database system, a front end system, a back end system, a personal computer system, and/or the like. In some embodiments, such as the one illustrated in FIG. 3, the user system 340 includes a communication interface 342, a processor 344, and a memory 346, which includes a datastore 348 and a cell level data encryption application 347. Also shown in memory 346 is a monitoring application 349. As shown, the communication interface 342 is operatively and selectively connected to the processor 344, which is operatively and selectively connected to the memory 346.

A communication interface, such as communication interface 332 and/or communication interface 342, generally includes hardware, and, in some instances, software, that enables a portion of the system 300, such as the management system 330 and/or the user system 342, to transport, send, receive, and/or otherwise communicate information to and/or from the communication interface of one or more other portions of the system 300. For example, the communication interface 332 of the management system 330 may include a modem, server, electrical connection, and/or other electronic device that operatively connects the management system 330 to another electronic device, such as the electronic devices that make up and/or communicate with the network 310. In another example, the communication interface 342 of the user system 340 may include a modem, server, electrical connection, and/or other electronic device that operatively connects the user system 340 to another electronic device, such as the electronic devices that make up and/or communicate with the network 310

Each processor described herein, including the processor 334 and/or the processor 344, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the cell level data encryption application of the memory 336 of the management system 330. In example implementations of processor 344, the processor 344 may also include functionality to operate one or more software programs based at least partially on computer-executable program code portions thereof, which may be stored, for example, in a memory device, such as in the cell level data encryption application of the memory 346 of the user system 340.

Each memory device described herein, including the memory 336 and/or memory 346 for storing the cell level data encryption application 337 and/or cell level data encryption application 347 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more pieces of information and data used by the system in which it resides to implement the functions of that system.

It will be appreciated that the cell level data encryption application 337 and cell level data encryption application 347 may be configured to implement any one or more portions of any one or more of the process flows 100 and/or 200 described and/or contemplated herein. As an example, in some embodiments, the cell level data encryption application 337 and/or cell level data encryption application 347 is configured to, in response to receiving an identifier of an aspect of a plurality of data values, apply an encryption protocol to a plurality of data values such that a first data value is encrypted and a second data value is unencrypted.

It will be understood that the cell level data encryption application 337 and/or cell level data encryption application 347 may be configured to perform any of the methods described herein, including, without limitation, those shown and described with respect to FIG. 1 and FIG. 2. It will also be understood that in some implementations, cell level data encryption application 337 and cell level data encryption application 347 may be configured to cause the management system 330 and/or user system 340 to be configured to transmit and receive information, such as a plurality of data values, one or more requests for a data value, and /or one or more identifiers of an aspect of a plurality of data values. It will also be understood that, in some embodiments, the cell level data encryption application 337 and/or cell level data encryption application 347 is configured to communicate with the datastore 338 and/or datastore 348, and/or any one or more other portions of the system 300.

It will be further understood that, in some embodiments, the cell level data encryption application 337 and/or cell level data encryption application 347 includes computer-executable program code portions for instructing the processor 334 and/or 344 to perform any one or more of the functions of the cell level data encryption application 337 and/or cell level data encryption application 347 described and/or contemplated herein. In some embodiments, the cell level data encryption application 337 and/or cell level data encryption application 347 may include and/or use one or more network and/or system communication protocols.

In addition to the cell level data encryption application 337, the memory 336 also includes the datastore 338. As used herein, the datastore 338 may be one or more distinct and/or remote datastores. In some embodiments, the datastore 338 is not located within the management system 330 and is instead located remotely from the management system 330. In some embodiments, the datastore 338 stores information regarding one or more pluralities of data values and/or one or more pluralities of data values.

In addition to the cell level data encryption application 337, the memory 336 also includes the monitoring application 339. In some example implementations, monitoring application 339 is an application that monitors and records actions taken by users of an entity's resources. In some such implementations, the monitoring application records actions taken by the employees of a financial institution such that whenever an employee interacts with customer information or performs some other action of interest the application records data about the action. For example, the monitoring application may record data about the time, date, and content of the action whenever an employee accesses or otherwise interacts with a customer's social security number, such as when the employee requests a credit score for the customer, processes a loan application, and/or examines a credit card account initiation. In another example, the monitoring application may record the content of a user interface display whenever an employee prints a copy of information associated with a customer. It will be appreciated, however, that implementations of a monitoring application such as monitoring application 339 and/or monitoring application 349 may adopt any approach in monitoring and/or recording actions taken by users of an entity's resources, including, but not limited to example implementations of system and environment 300. It will also be appreciated that in some implementations, monitoring application 339 and/or monitoring application 349 may be omitted and/or implemented in accordance with another approach such as inclusion in the network 310 or in another system.

It will be understood that the datastore 338 and/or datastore 348 may include any one or more storage devices, including, but not limited to, datastores, databases, and/or any of the other storage devices typically associated with a computer system. It will also be understood that the datastore 338 and/or 348 may store information in any known way, such as, for example, by using one or more computer codes and/or languages, alphanumeric character strings, data sets, figures, tables, charts, links, documents, and/or the like. Further, in some example embodiments, the datastore 338 and/or datastore 348 may include information associated with one or more applications, including, but not limited to, the cell level data encryption application 337 and/or cell level data encryption application 347. It will also be understood that, in some embodiments, the datastore 338 and/or datastore 348 provides a substantially real-time representation of the information stored therein, so that, for example, when the processor 334 accesses the datastore 338, the information stored therein is current or substantially current.

It will be understood that the embodiment illustrated in FIG. 3 is exemplary and that other implementations may vary. As another example, in some implementations, the management system 330 includes more, less, or different components, such as, for example, a user interface. In these and some other example implementations, the user system 340 includes more, less, or different components, such as, for example, a user interface. As another example, in some embodiments, some or all of the portions of the system 300 may be combined into a single portion. Likewise, in some embodiments, some or all of the portions of the system 300 may be separated into two or more distinct portions.

It will also be understood that the system 300 may include and/or implement any embodiment of the present invention described and/or contemplated herein.

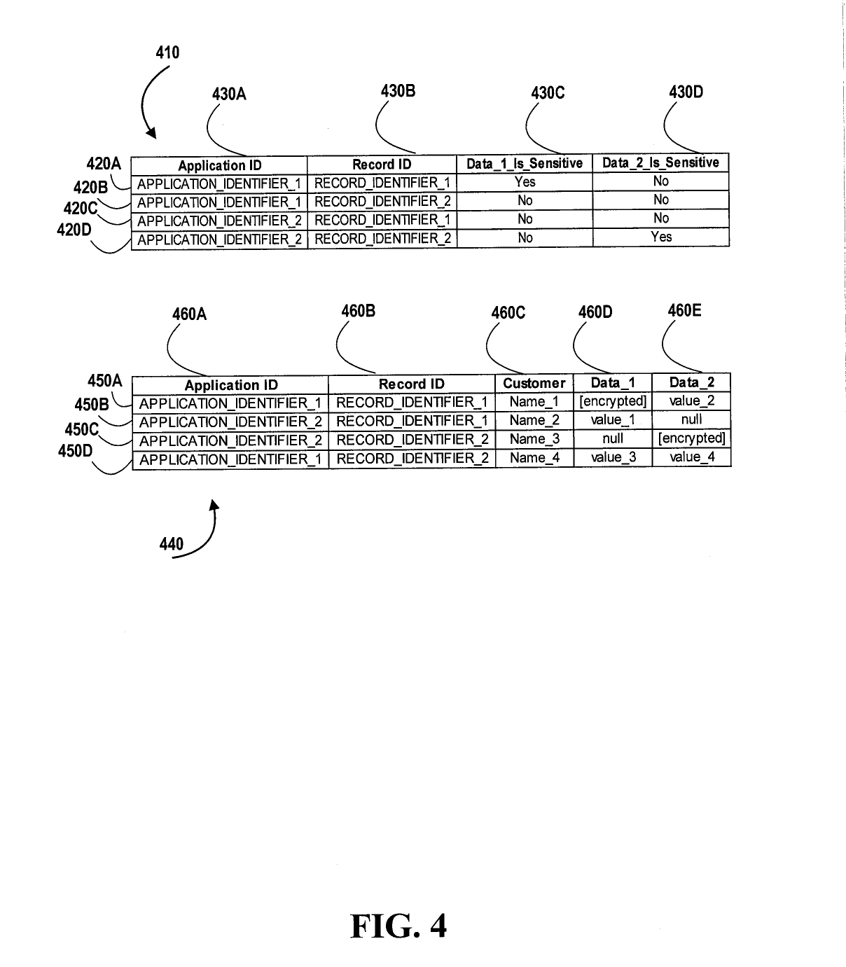

FIG. 4 depicts two databases that are used in an example implementation of an aspect of the invention. As shown in FIG. 4, data sensitivity table 410 is presented as a spreadsheet with a plurality of rows and 420a-420d and a plurality of columns 430a-430d. As shown, column 430a is labeled “Application ID,” column 430b is labeled “Record ID,” column 430c is labeled “Data_1_Is_Sensitive,” and column 430d is labeled “Data_2_Is_Sensitive”. Data sensitivity table 410 is an example of a table that correlates an identification of an application and a data format and/or record type with an encryption protocol. As used herein, a cell is the space available for receiving one or more data values found at the intersection of a row and a column.

As shown in FIG. 4, data values table 440 is a portion of a database presented as spreadsheet with rows 450a-450d and columns 460a-460e, labeled “Application ID,” “Record ID,” “Customer,” “Data_1,” and “Data_2”, respectively. It will be appreciated that data values table 440 contemplates a degree of flexibility in the sense that columns 460d and 460e (Data_1 and Data_2, respectively) are not assigned a particular data type. In example implementations of data values table 440, it is contemplated that the data values table 440 will contain information received from a plurality of different sources, such as various applications, wherein the data formats and/or record types associated with the received data values may differ from one application and/or record type to another.

As shown in row 420a, the application identification is APPLICATION_IDENTIFIER_1, the record identification is RECORD_IDENTIFIER_1, and the encryption protocol indicates that the content of Data_1 is sensitive and the content of Data_2 is not sensitive. In some example implementations of some of the methods, apparatuses and computer program products described herein, in response to receiving APPLICATION_IDENTIFIER_1 and RECORD_IDENTIFIER_2, an encryption protocol is applied such that the data value in Data _1 is encrypted and the data value in Data_2 is not encrypted. As shown in data sensitivity table 410, the encryption protocols in rows 420b and 420c show that neither Data_1 nor Data_2 should be encrypted for their respective application and record identifiers, and the encryption protocol in row 420d shows that Data _1 should remain unencrypted and Data_2 should be encrypted in response to receiving its corresponding application and record identifiers.

As shown in data values table 440, encryption protocols contained in data sensitivity table 410 have been applied to the data values in the table, such that the value of Data_1 in row 450a is encrypted, the value of Data_2 in row 450c is encrypted, and the remaining values are unencrypted, in accordance with their respective encryption protocols.

It will be appreciated that the example implementation presented in FIG. 4 depicts one way that sensitive data may be selectively encrypted on a cell-by-cell basis. Since the example shown in FIG. 4 contemplates a database, there is one table, shown as data sensitivity table 410, that identifies sensitive fields that occur in another table, shown as data values table 440. However, it will be appreciated that one or more other tables could define sensitive fields in one or more other tables in a single database and/or across an array of databases. It will also be appreciated that example implementations of the methods, apparatuses, and computer program products described herein could use other types of data storage including, but not limited to, fields, lines, and/or records in a data file; and could contemplate selective encryption at the field level, line level, and/or record level including, but not limited to, fields within records in a hash table or array stored in memory accessible by a computer. While many such example implementations contemplate data that resides in a storage medium, it will be appreciated that cell level data encryption can apply to data in flight, such as data in a transmission.

In some example implementations contemplating data values in flight, the data values are being communicated between, for example, two or more computers when the cell level data encryption is applied. For example, the data values may be transmitted between a web server in a central data center and an end-user's browser running on the user's desktop computer. In other example implementations, the data values are sent between two or more web services, such as a financial institution's servers and servers associated with a credit-reporting bureau, two databases, such as a database and a financial institution branch that transmits information to the financial institution's central server, and/or any other source sending data values to a destination. It will be appreciated that any approach to identifying which aspects and/or portions of a specific data stream are sensitive and applying an encryption protocol to that specific data stream may be used in example implementations.

Thus, present embodiments of the invention described above provide for cell level data encryption. The methods, apparatuses, and computer program products herein described provide for the encryption of individual data values without requiring adjacent data values to also be encrypted. For example, in situations where individual data values are arranged in a database that is visualized as a two-dimensional representation, one or more individual data values may be encrypted without requiring horizontally or vertically adjacent data values to also be encrypted. In situations where data values are transmitted and visualized as a sequential stream of data values, one data value may be encrypted without requiring previous or subsequent data values to be encrypted. In some such examples, an individual data value may be encrypted without requiring the entire transmission channel to be encrypted.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications, and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for cell-level data encryption, the method comprising:
receiving via a computing device an identifier of an aspect of a plurality of data values;
in response to receiving via a computing device the identifier associated with an aspect of the plurality of data values, applying via a computing device processor an encryption protocol to the plurality of data values such that a first data value in the plurality of data values is encrypted and a second data value in the plurality of data values is unencrypted; and
providing a modified plurality of data values, comprising an encrypted copy of the first data value and an unencrypted copy of the second data value.

2. The method of claim 1 wherein the plurality of data values comprises a database and is stored in a computer-readable medium.

3. The method of claim 1 wherein the plurality of data values is a portion of a transmission.

4. The method of claim 1, wherein the identifier of an aspect of a plurality of data values comprises an identification of an application associated with the plurality of data.

5. The method of claim 4 wherein the identifier of an aspect of a plurality of data values comprises an identification of an application associated with the plurality of data and an identification of a data format associated with the application.

6. The method of claim 5 wherein applying via a computing device processor an encryption protocol to the plurality of data values such that a first data value in the plurality of data values is encrypted and a second data value in the plurality of data values is unencrypted comprises:
identifying via a computing device processor the identification of an application associated with the plurality of data and the identification of a data format associated with the application; and
selecting via a computing device processor an encryption protocol from among a plurality of encryption protocols, wherein the selected protocol is associated with the identification of an application associated with the plurality of data and the identification of a data format associated with the application.

7. The method of claim 1 further comprising:
receiving via a computing device a request for the first data value;
determining via a computing device processor that the request for the first data value comprises an authorization to view the first data value; and
in response to determining that the request comprises an authorization to view the first data value, providing via a computer device processor for production of an unencrypted copy of the first data value.

8. An apparatus for encrypting data, the apparatus comprising:
a computing device comprising a memory and at least one processor; and
a cell level data encryption application stored in the memory and executable by the processor to:
receive an identifier of an aspect of a plurality of data values;
in response to receiving the identifier associated with an aspect of the plurality of data values, apply an encryption protocol to the plurality of data values such that a first data value in the plurality of data values is encrypted and a second data value in the plurality of data values is unencrypted; and
provide a modified plurality of data values, comprising an encrypted copy of the first data value and an unencrypted copy of the second data value.

9. The apparatus of claim 8 wherein the plurality of data values comprises a database and is stored in a computer-readable medium.

10. The apparatus of claim 8 wherein the plurality of data values is a portion of a transmission.

11. The apparatus of claim 8, wherein the identifier of an aspect of a plurality of data values comprises an identification of an application associated with the plurality of data.

12. The apparatus of claim 11 wherein the identifier of an aspect of a plurality of data values comprises an identification of an application associated with the plurality of data and an identification of a data format associated with the application.

13. The apparatus of claim 12 wherein the cell level data encryption application is further configured to:
identify the identification of an application associated with the plurality of data and the identification of a data format associated with the application; and
select an encryption protocol from among a plurality of encryption protocols, wherein the selected protocol is associated with the identification of an application associated with the plurality of data and the identification of a data format associated with the application.

14. The apparatus of claim 8 wherein the cell level data encryption application is further configured to:
receive a request for the first data value;
determine that the request for the first data value comprises an authorization to view the first data value; and
in response to determining that the request comprises an authorization to view the first data value, provide for production of an unencrypted copy of the first data value.

15. A computer program product comprising:
a non-transitory computer-readable medium comprising:
a first set of codes for causing a computer to be configured for receiving via a computing device an identifier of an aspect of a plurality of data values;
a second set of codes for causing a computer to be configured for in response to receiving via a computing device the identifier associated with an aspect of the plurality of data values, applying via a computing device processor an encryption protocol to the plurality of data values such that a first data value in the plurality of data values is encrypted and a second data value in the plurality of data values is unencrypted; and
a third set of codes for causing a computer to be configured for providing a modified plurality of data values, comprising an encrypted copy of the first data value and an unencrypted copy of the second data value.

16. The computer program product of claim 15 wherein the plurality of data values comprises a database and is stored in a computer-readable medium.

17. The computer program product of claim 15 wherein the plurality of data values is a portion of a transmission.

18. The computer program product of claim 15, wherein the identifier of an aspect of a plurality of data values comprises an identification of an application associated with the plurality of data.

19. The computer program product of claim 18 wherein the identifier of an aspect of a plurality of data values comprises an identification of an application associated with the plurality of data and an identification of a data format associated with the application.

20. The computer program product of claim 19 wherein the second set of codes for causing a computer to be configured for applying via a computing device processor an encryption protocol to the plurality of data values such that a first data value in the plurality of data values is encrypted and a second data value in the plurality of data values is unencrypted comprises:
a fourth set of codes for causing a computer to be configured for identifying via a computing device processor the identification of an application associated with the plurality of data and the identification of a data format associated with the application; and
A fifth set of codes for causing a computer to be configured for selecting via a computing device processor an encryption protocol from among a plurality of encryption protocols, wherein the selected protocol is associated with the identification of an application associated with the plurality of data and the identification of a data format associated with the application.

21. The computer program product of claim 15 further comprising:
a fourth set of codes for causing a computer to be configured for receiving via a computing device a request for the first data value;
a fifth set of codes for causing a computer to be configured for determining via a computing device processor that the request for the first data value comprises an authorization to view the first data value; and
a sixth set of codes for causing a computer to be configured for in response to determining that the request comprises an authorization to view the first data value, providing via a computer device processor for production of an unencrypted copy of the first data value.

22. A method for cell-level data encryption, the method comprising:
receiving via a computing device a plurality of data values, wherein the plurality of data values is configured as a spreadsheet, wherein the spreadsheet comprises a plurality of cells;
receiving via a computing device an identifier of an aspect of a plurality of data values, wherein the identifier is associated with a monitoring application;
in response to receiving via a computing device the identifier associated with an aspect of the plurality of data values, applying via a computing device processor an encryption protocol to the plurality of data values such that a first data value stored in a first cell of the spreadsheet is encrypted and a second data value stored in a second cell of the spreadsheet is unencrypted; and
providing a modified spreadsheet, comprising an encrypted copy of the first data value and an unencrypted copy of the second data value.

23. The method of claim 22 wherein the plurality of data values comprises data regarding an interaction between an employee of a financial institution and information associated with a customer of the financial institution.

24. The method of claim 22, wherein the monitoring application records data regarding an action performed by an employee of a financial institution.
